(19) United States
(12) Patent Application Publication
(10) Pub. No.: US 2013/0327419 A1
(43) Pub. Date: Dec. 12, 2013

(54) ANTIMICROBIAL DEVICE

(71) Applicant: APPLIED SILVER, INC., Hayward, CA (US)

(72) Inventor: Sean Morham, Napa, CA (US)

(73) Assignee: APPLIED SILVER, INC., Hayward, CA (US)

(21) Appl. No.: 13/968,084

(22) Filed: Aug. 15, 2013

Related U.S. Application Data
(63) Continuation-in-part of application No. 13/402,771, filed on Feb. 22, 2012.

(51) Int. Cl. B01F 1/00

(52) U.S. Cl. CPC B01F 1/0027
USPC 137/268

(57) ABSTRACT

Under electronic monitoring and control, fluids flow into a fluid diffusion device to form a fluid combination. The fluid combination has corrosive properties as it flows into an antimicrobial canister housing an insert with antimicrobial metallic coated media and associated support. The fluid combination corrodes the antimicrobial metallic coated media located inside the antimicrobial canister. Upon exiting the antimicrobial canister, the fluid combination contains dissolved metal ions and is a liquid antimicrobial agent. Monitors throughout the system ensure the antimicrobial agent is being produced at the desired level and rate as it exits into its application.

### REFERENCE TO RELATED APPLICATIONS

This application is a continuation in part of application Ser. No. 13/402,771 filed on Feb. 22, 2012 entitled ANTI-MICROBIAL DEVICE the disclosure of which is incorporated herein by reference.

### BACKGROUND OF THE INVENTION

1. Field

The present invention is in the technical field of antimicrobial treatment. More particularly, the present invention provides a system employing a metallic source substrate supported in a fluid combination flow with controlled fluid diffusion inducing metallic ion and microscopic particle generation in desired concentration, for entrainment in the flow, for use in antimicrobial treatments.

2. Related Art

Shortcomings of existing antimicrobial treatments can lead to the spread of infection through direct contact, airborne disease and waterborne disease. These diseases can be acquired by their victims from contacting contaminated surfaces, breathing air containing pathogens, or drinking pathogen containing water. Contaminated drinking water especially affects populations of second world and third world countries. The lack of inexpensive means to rid drinking water of harmful living microbes results in widespread illness and death in second world and third world countries. Similarly, contamination of fabrics or linens in uniforms, surgical scrubs, sheets, blankets, napkins, table cloths and similar materials by microbial pathogens can contribute to spread of disease.

Previous antimicrobial treatments require concentrated chemicals which are potentially or actually harmful to people and the environment. Such antimicrobial treatments also do not provide a lasting antimicrobial effect after the treatment has been administered. Existing antimicrobial treatments can also lead to immunization of evolved pathogens to the respective treatment. Such immunization of evolved pathogens can result in infections which cannot be treated with the conventional treatments that caused the pathogens to become immune.

Enterprises which specifically have problems with the spread of infectious diseases include, but are not limited to: the cruise line industry, hotel and gaming, professional sports teams, health and fitness clubs, nursing homes, and hospitals. Healthcare facilities currently have a growing problem with immunized pathogens being virtually untreatable with conventional methods. With such hospital infections, the harmful microbes are often carried in the linens and clothing provided by the hospital. Once hospital linens have been laundered and treated, they are susceptible to recontamination by microbes and pathogens. Pathogens carried by these linens can infect hospital patients and even cause death.

It is therefore desirable to provide an antimicrobial treatment system which may be employed directly in water supply systems to provide efficacious antimicrobial action.

### SUMMARY OF THE INVENTION

The present invention is a device which releases a lasting, metallic, antimicrobial agent to which no known pathogens can become immune. Embodiments of the antimicrobial device disclosed herein incorporate antimicrobial metallic ion coated media suspended for intimate contact with a turbulated fluid combination flow. A housing contains the media and has an inlet and outlet for the fluid combination. A fluid diffusion device is connected upstream of the housing inlet and receives one fluid at a fluid inlet and a different fluid at a diffusion inlet. Control of flow of separate fluids into the fluid diffusion device maximizes entrainment of antimicrobial metallic ions from the media contained within the housing.

### BRIEF DESCRIPTION OF THE DRAWINGS

These and other features and advantages of the present invention will be better understood by reference to the following detailed description of exemplary embodiments when considered in connection with the accompanying drawings wherein:

FIG. 1A is an exploded isometric view of a metallic antimicrobial coated substrate, support frame and porous body;

FIG. 1B is a top view of layered antimicrobial metallic coated substrate for flow compensation;

FIG. 1C is a side view of the layered antimicrobial metallic coated substrate of FIG. 1B with thickness exaggerated for clarity;

FIG. 2A is an end view of the antimicrobial metallic coated substrate, support frame and porous body rolled into the orientation for insertion into the central cylinder used in the present invention;

FIG. 2B is an end view showing securing elements employed in intermediate wraps of the antimicrobial metallic coated substrate, support frame and porous body;

FIG. 2C is an top view of the embodiment of FIG. 2B;

FIG. 3A is a side view of the canister housing the antimicrobial metallic coated substrate, support frame and porous body with a cut away of the central cylinder used to house the rolled combination of elements;

FIG. 3B is a perspective view of a first embodiment of a flow distribution puck employed in the canister;

FIG. 3C is a perspective view of a second embodiment of a flow distribution puck employed in the canister;

FIG. 3D is a pictorial bottom view of an alternative embodiment for antimicrobial metallic media support in a puck;

FIG. 3E is a pictorial view of stacked pucks in the canister with varying antimicrobial metallic media density;

FIG. 4 is a three quarters view of a fluid diffusion sub-assembly which is used in the present invention;

FIG. 5 is a system flow diagram of and exemplary embodiment of the electronic control and monitoring system, separate fluid lines, fluid diffusion sub-assembly and antimicrobial canister;

FIG. 6 is a general firmware flow diagram for the electronic control and monitoring system which includes the following major states and modes: INITIALIZATION, IDLE, PROCESS and SHUTDOWN;

FIG. 7 is a software flow diagram specific to when the electronic control and monitoring system enters INITIALIZATION sequence;

FIG. 8 is a software flow diagram specific to when the electronic control and monitoring system enters the IDLE state;

FIG. 9 is a software flow diagram specific to when the electronic control and monitoring system enters PROCESS mode;

FIG. 10 is a software flow diagram specific to when the electronic control and monitoring system enters the SHUTDOWN state;

FIG. 11 is a schematic representation of an industrial washing system showing placement of the antimicrobial device for use with a Continuous Batch Washer (CBW);

FIG. 12 is a schematic view of a set of auxiliary components which are used to collect and dispense the antimicrobial solutions for textile treatment (i) in Conventional Washer-Extractors (CWE) or (ii) when the demand flow rate of any form of a CBW or CWE exceeds the output flow rate of the antimicrobial device; and,

FIG. 13 is a schematic view of a simplified embodiment of the canister, fluid diffusion assembly and resistivity sensors.

### DETAILED DESCRIPTION OF THE INVENTION

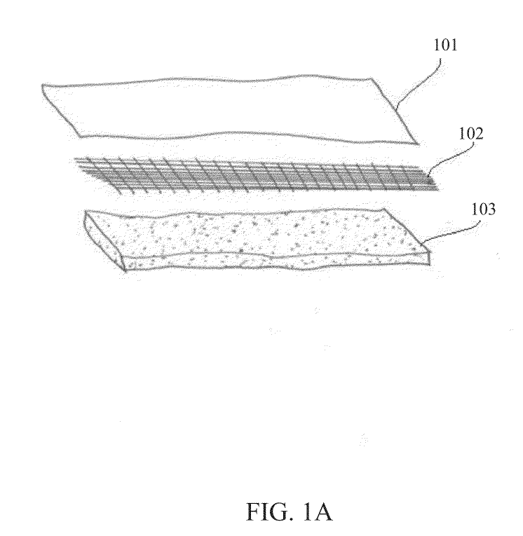

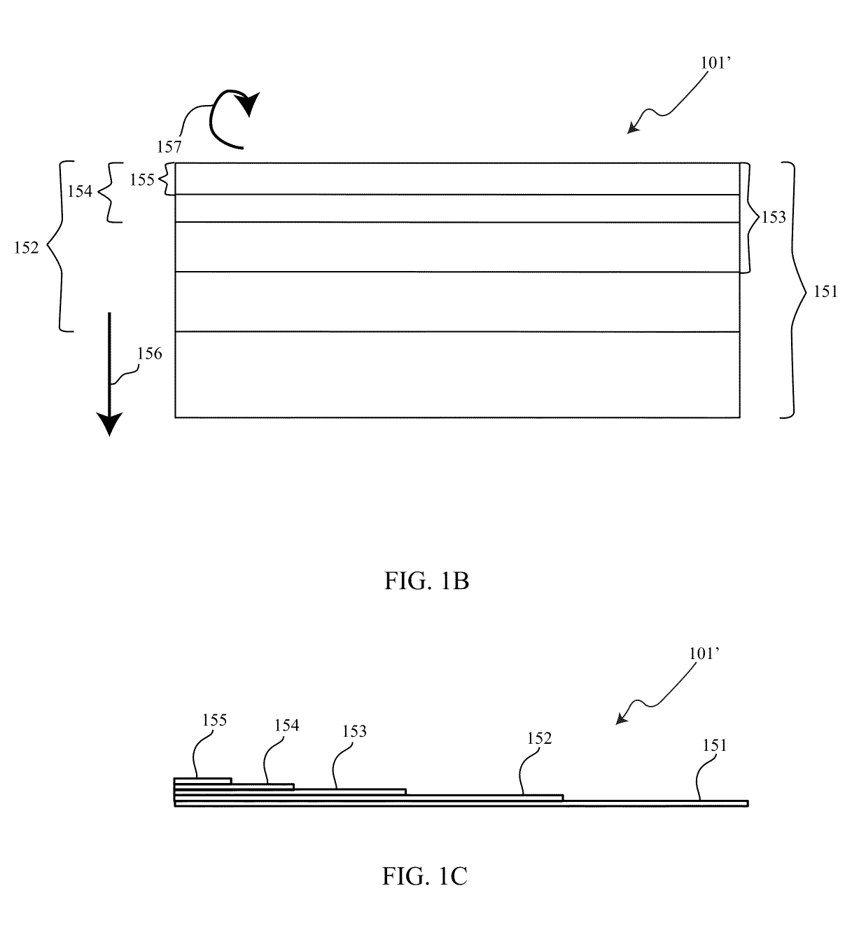

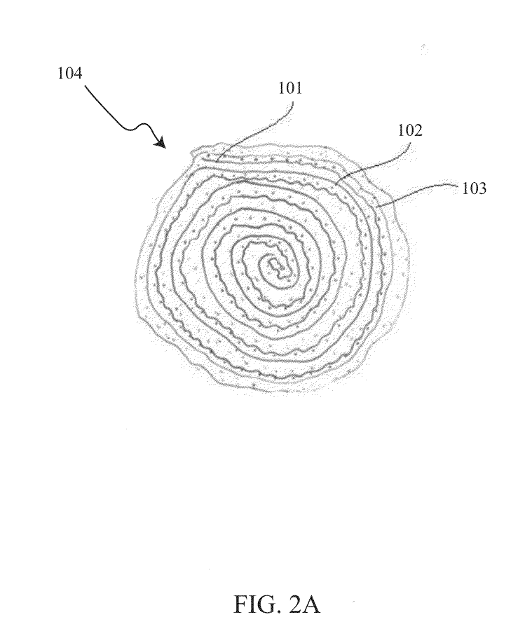

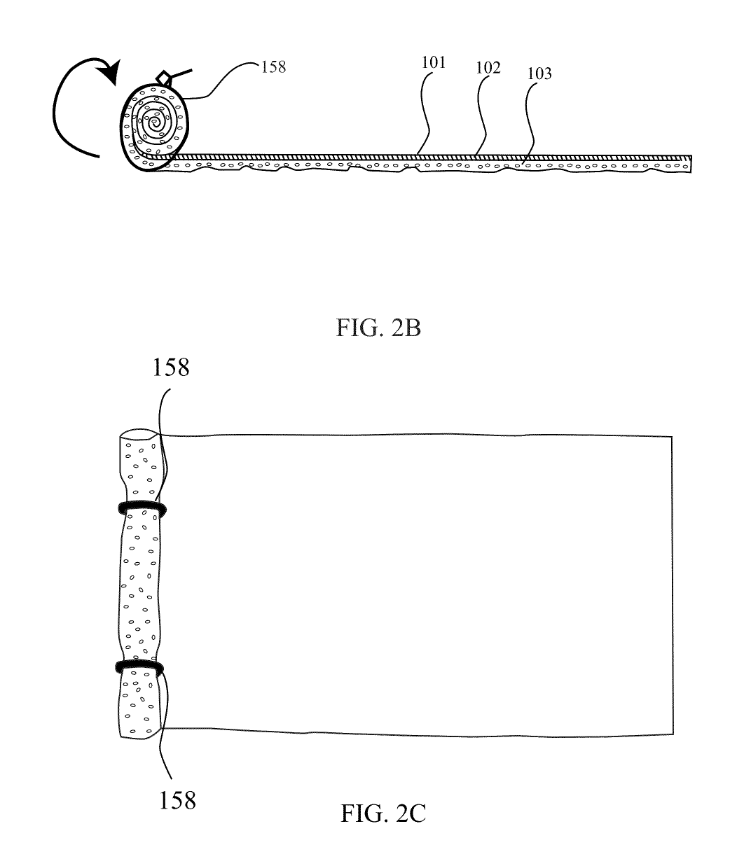

The embodiments disclosed herein provide a system for entraining metallic ions, silver ions in an exemplary embodiment, into a water stream employed in washing linens to allow a desired concentration of metallic ions to be entrapped in the linens for continuing antimicrobial action within the linen. Describing an embodiment of the invention in more detail with reference to the drawings, FIG. 1A shows an antimicrobial metallic coated substrate 101 above a support frame 102. A porous body 103 shown at the bottom of FIG. 1A is used to suspend and maintain separation of the antimicrobial metallic coated substrate 101 and the support frame 102 in a rolled configuration. The antimicrobial metallic coated substrate 101, support frame 102 and porous body 103 are rolled in a helix forming continuous expanding layers, referred to herein as a roll 104, as shown in FIG. 2A.

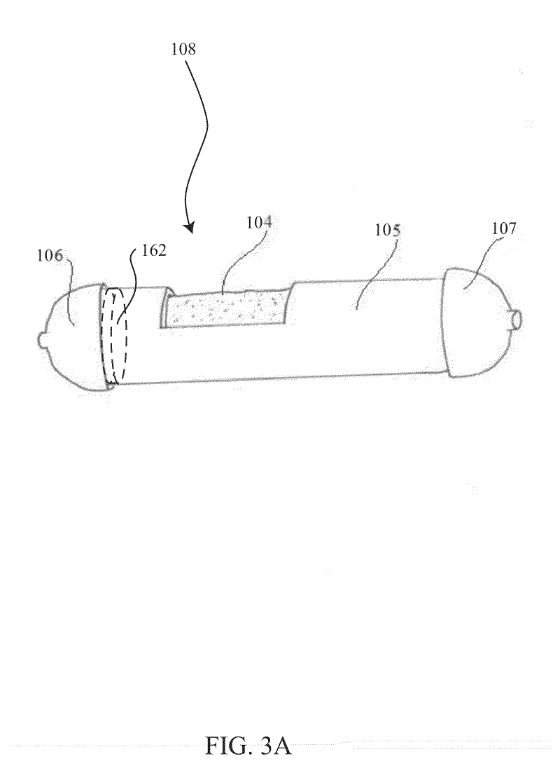

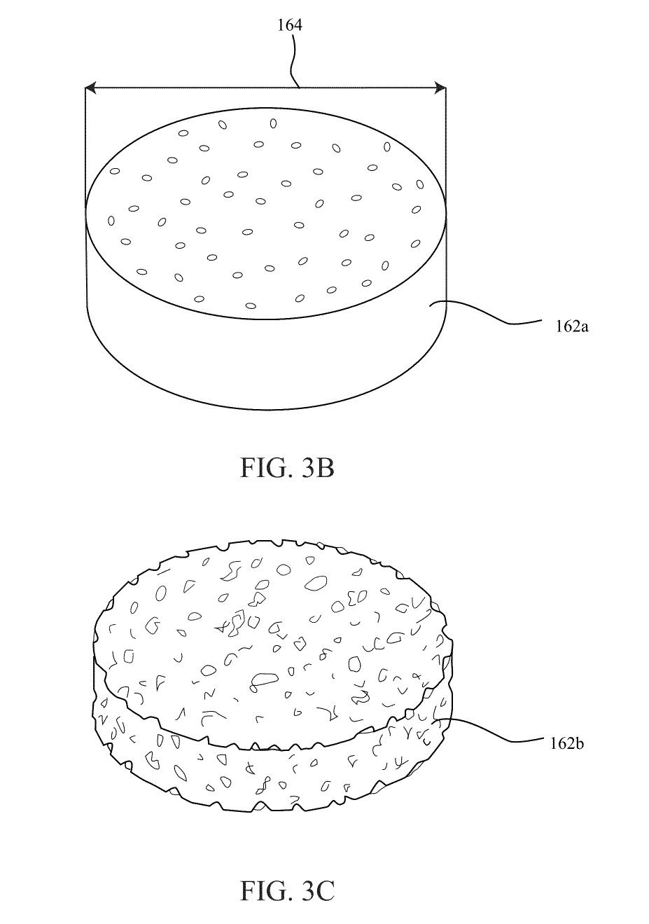

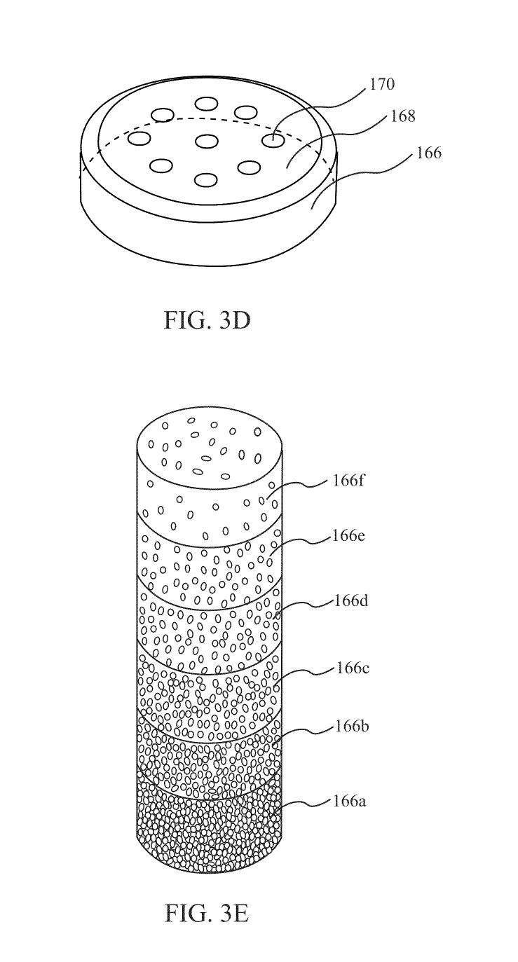

FIG. 3A shows a canister 108 employing a central cylinder 105 in which the roll 104 shown in FIG. 2A is inserted. The central cylinder 105 houses the roll 104 while allowing fluids to enter and exit the central cylinder 105 through end caps 106 and 107. The roll 104 inserted into the central cylinder 105 and held in place by inlet end cap 106 and outlet end cap 107 as an assembly referred to as the antimicrobial canister 108.

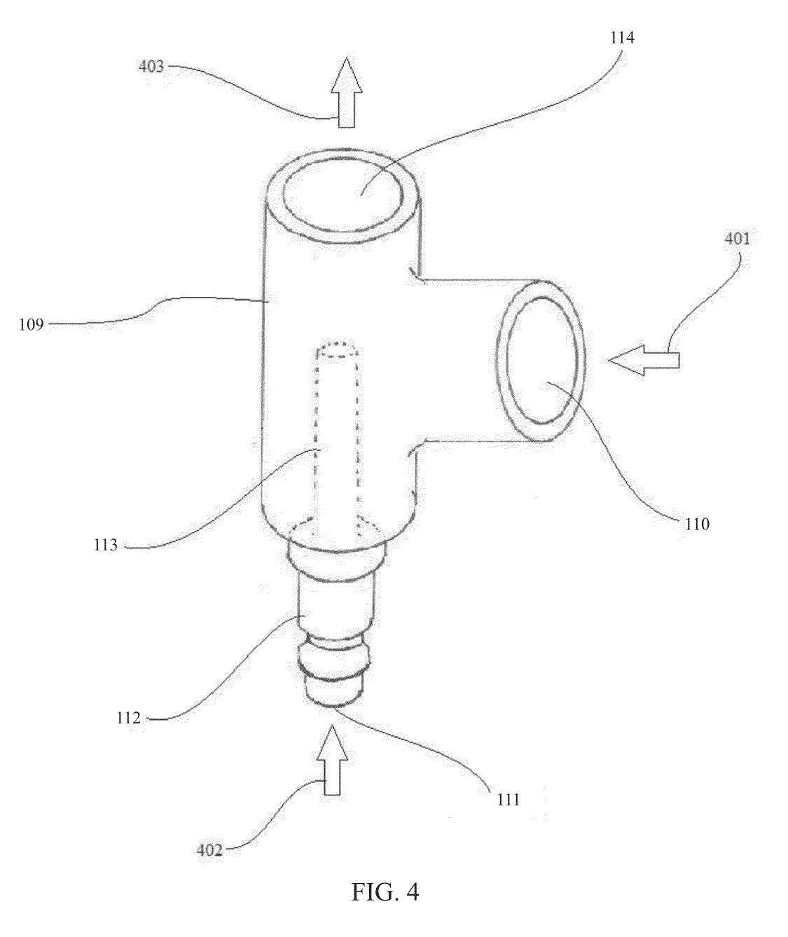

FIG. 4 shows a fluid diffusion device 109 used in combination with the canister 108 in the embodiment shown in the drawings to be described in greater detail subsequently. The fluid diffusion device 109 allows a first fluid (fluid #1) to flow into a fluid inlet 110 in the direction of arrow 401 and through a central cavity 404 in a main body 405. A second fluid (fluid #2) is injected through a fluid diffusion inlet 111 and barb 112 in the direction of arrow 402. Once through the barb 112, the second fluid enters a connected diffuser 113 which is oriented parallel to the main body 405 of the fluid diffusion device 109. The second fluid acts as a turbulating agent and diffuses into first fluid in the cavity 404 of the main body 405 to form a fluid combination. Turbulation of the fluid enhances corrosiveness of the fluid, as will be described in greater detail subsequently, for improved entrainment of antimicrobial metallic ions from the substrate 101 in the canister 108. The fluid combination exits the fluid diffusion device 109 through the fluid combination outlet 114 in the direction of arrow 403. The fluid diffusion device 109 is connected to the canister 8 such that the fluid combination flows then through the antimicrobial canister 108 as will be described in greater detail subsequently. Fluid #1 and fluid #2 can be any fluid combination, however, because fluid #1 is most commonly water and fluid #2 is most commonly air, the specific embodiments of the present invention will be described using these specific exemplary fluids. In certain embodiments, gaseous oxygen could be substituted for air as the turbulating agent for enhanced oxygenation of the water.

To achieve desired concentration of antimicrobial metallic ions in a water stream flowing through the fluid diffusion device 109 and canister 108 analysis demonstrates that the fluid combination entrains antimicrobial metallic ions as a log function with respect to uptake time (contact time of the fluid combination with the substrate in the canister), uptake function Y=A ln(x)-B, where Y is the entrained ion concentration in parts per million (ppm) and x is the uptake time (seconds). Constants A and B are determined, in part, and controlled by the corrosive action induced by the diffusion device 109 into the fluid combination. Further, the achieved concentration may be viewed in terms of a rate of entrainment of ions by the fluid combination, or uptake rate, as the derivative of the described uptake function, Y′=A/x. The entering fluid provides the greatest gradient for ion entrainment into solution. While saturation is not attained within the canister, increasing ion concentration in the fluid flowing through the canister decreases the entrainment rate. By varying the concentration of silver available for release of antimicrobial metallic ions along the substrate 101 in the flow direction proportional to the uptake rate, a constant ion entrainment concentration output may be obtained throughout the usage lifetime of the canisterl08. Depletion of ions from the graduated higher concentration of metallic coating on the substrate as fluid flows from the inlet allows consistent metallic ion concentration at the outlet as the canister ages. Establishing a gradient of antimicrobial metallic ion concentration in a substrate 101′ may be accomplished through several approaches. FIGS. 1B and 1C demonstrate an easily fabricated embodiment wherein multiple layers of substrate, 151, 152, 153, 154 and 155, each impregnated with a consistent concentration of antimicrobial metallic ions, but of varying length are overlayed thereby forming a combined substrate with a varying effective concentration of available ions along a flow direction, annotated by arrow 156 in FIG. 1B. Length of the individual layers may be determined to approximate the uptake function. Rolling of the substrate 101′ with a porous body and support frame transverse to the flow direction as previously described with respect to FIG. 2A provides a completed roll 104 for insertion into the canister 108. In alternative embodiments, the gradient of antimicrobial metallic ions may be obtained by selective impregnation of ions into a single layer substrate with a varying concentration along the width of the substrate.

Employing a gradient of antimicrobial metallic ion concentration along the length of the canister 108 additionally promotes consistent depletion of the ions along the length of the substrate 101′ enhancing the operational life of the canister.

Control of the helical wrapping of the roll 104 as shown in FIG. 2A is desirable to achieve consistent dimensional spacing between the expanding layers in the roll to provide a constant flow cross section in each layer with respect to the porous body 103 and substrate 101 as supported on the support frame 102. Flexion caused by the resiliency of the support frame 102 and porous body 103 tends to unroll or expand the inner layers when the roll is only constrained at the outer diameter. In an exemplary embodiment shown in FIGS. 2B and 2C, fasteners 108 are inserted periodically during the rolling of the roll 104 to maintain a constant tension in the helical layers. In an exemplary embodiment, zip ties are employed as the fasteners, piercing the roll with the zip tie during the rolling process and encircling the partial roll with the secured zip tie. However, in alternative embodiments threaded fasteners inserted diametrically, stitching or adhesive applied periodically at the roll interface may be employed.

To achieve consistent flow of the fluid combination in the layers of the helical roll 104 or canister insert 160, a flow distribution puck 162 is employed adjacent the inlet end cap 106 of the canister 108 as shown in FIG. 3A. As shown in detail in FIGS. 3B and 3C, the flow distribution puck may employ a perforated structure such as puck 162a or a porous structure such as puck 162b. The perforations may be obtained in puck 162a by drilling or direct forming. An exemplary porous structure for puck 162b may be obtained by employing expanded reticulated foam or similar materials sintered inert metals, porous ceramics, metallic foam (cast in the presence of gaseous bubbles). Each flow distribution puck has a diameter 164 substantially equal to an inner diameter of the canister 108. The fluid combination entering through the inlet end cap 106 is thereby distributed substantially equally across the entire cross section of the canister 108 providing equal flow through each of the layers of the roll 104 or canister insert 160.

As an alternative to the roll 104 and canister insert 160, support of antimicrobial metallic ion bearing media within the canister 108 may be accomplished by employing a plurality of disks 166 as shown in FIG. 3D. Each disk 166 is a cylindrical container with a perforated end 168 having flow apertures 170 to allow flow of the fluid combination through the disk. The ion bearing media employed may be resin beads coated with the antimicrobial metallic ions, a substrate impregnated with antimicrobial metallic ions shredded to form a “confetti”, a fibrous metallic wool or metallic salt crystals. A complete insert 172 for the canister 108 as shown in FIG. 3E may employ a stack of individual disks 166a-166f. Each disk may contain a predetermined quantity of the metallic or metallic compound coated media to achieve a desired gradient of antimicrobial metallic ion concentration uptake along the length of the canister 108 to approximate the uptake rate function as previously described. The disks 166 may employ a beveled edge 174 as shown in FIG. 3D or similar nesting geometry for mating with adjacent disks in the insert 172.

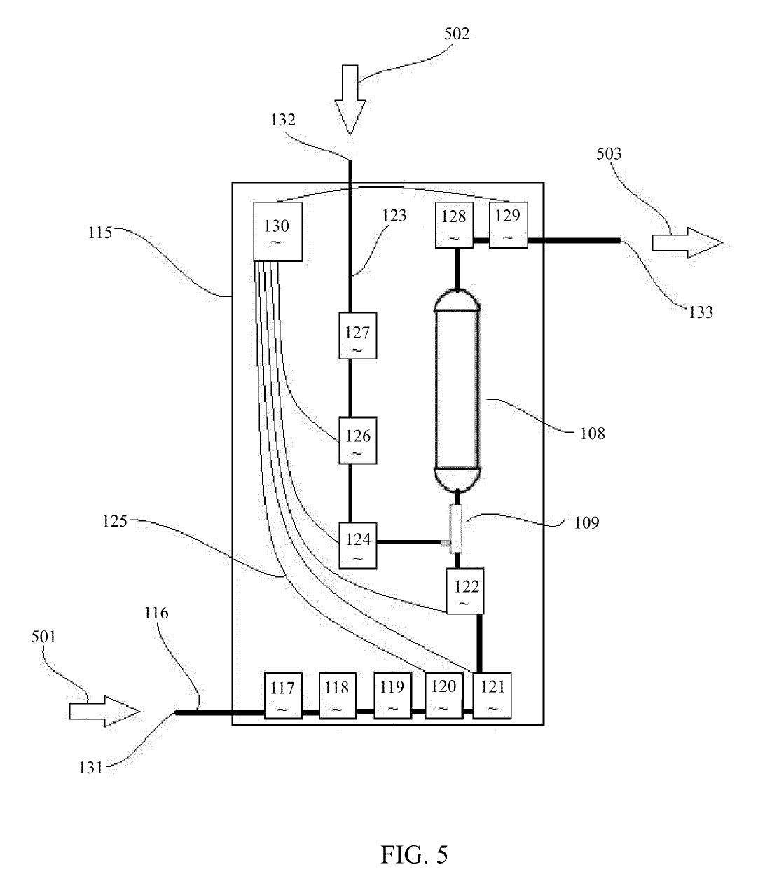

FIG. 5 shows a system flow diagram of an embodiment of the canister 108 and fluid diffusion device 109 with an electronic control and monitoring system. FIG. 5 shows seven electronic devices, three mechanical regulators, the antimicrobial canister 108, and the fluid diffusion device 109, a manual water shut off 117, a water filter 119, water inlet 131, air inlet 132, and the antimicrobial fluid combination outlet 133. The seven electronic devices which will be described in greater detail subsequently are: an electronics module 130, which is a programmable device such as a microprocessor having software or firmware for specific INITIALIZATION; IDLE; PROCESS; and SHUTDOWN sequences, a solenoid water shut off valve 120, a water temperature sensor 121, a water pressure sensor 122, a air pressure sensor 124, a solenoid air shut off valve 126, and a flow sensor 129.

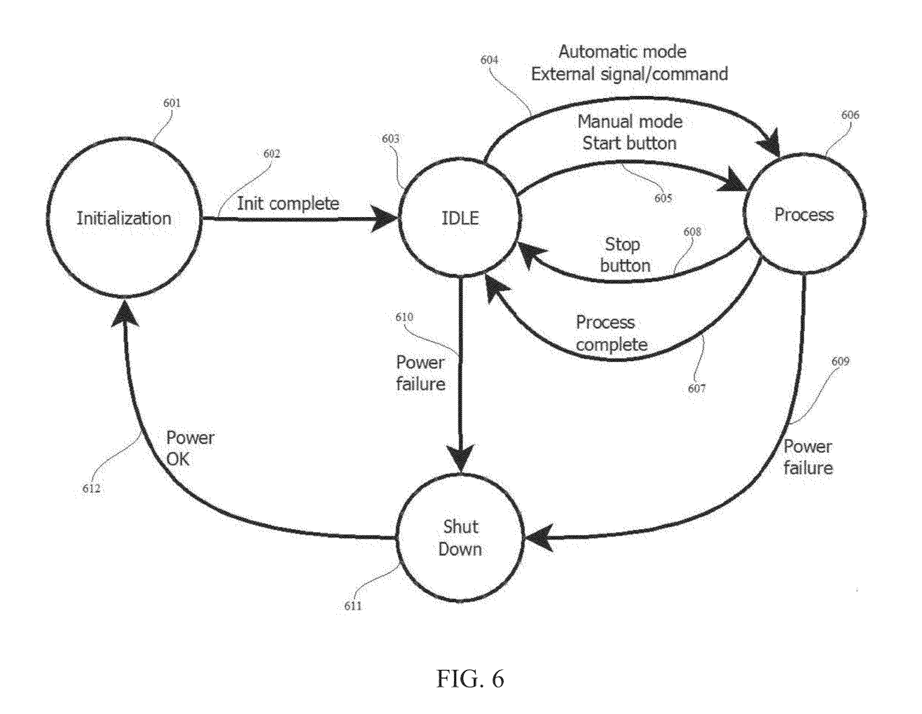

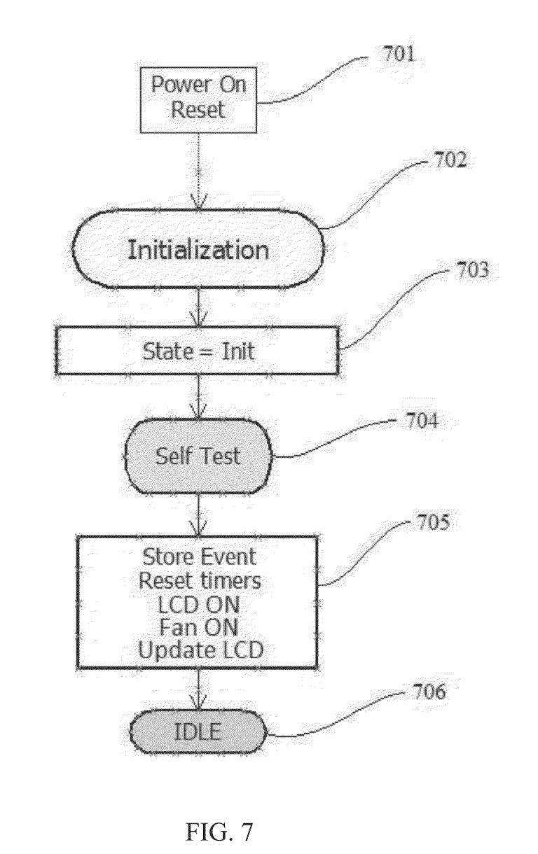

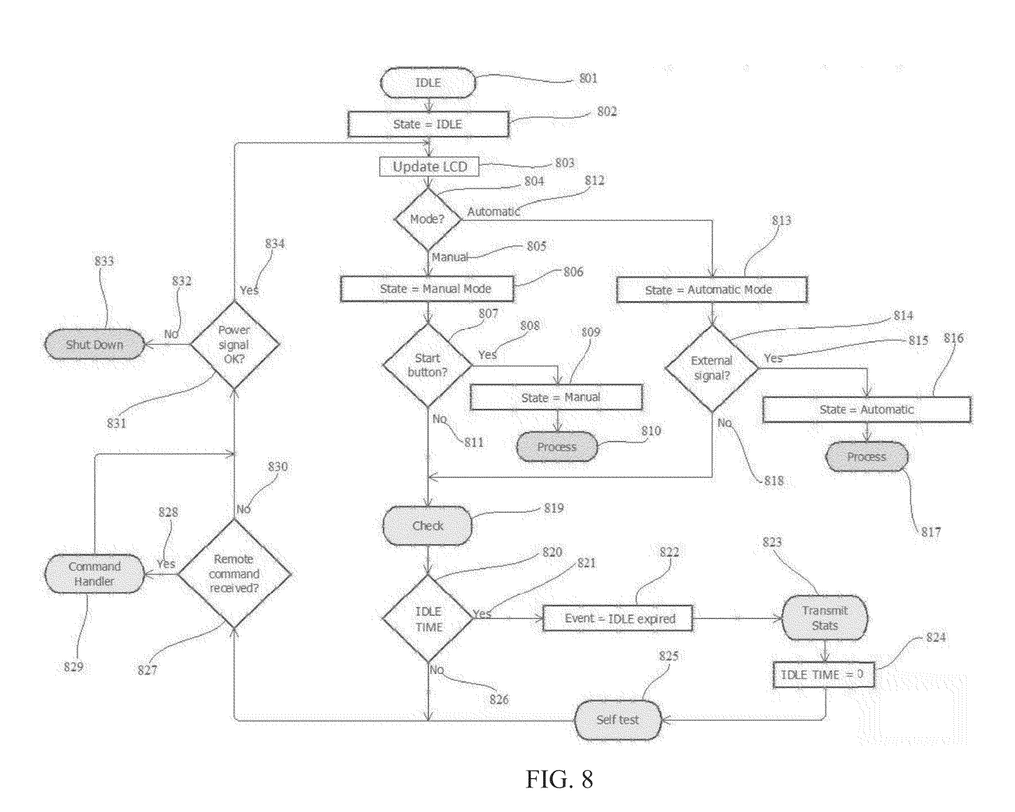

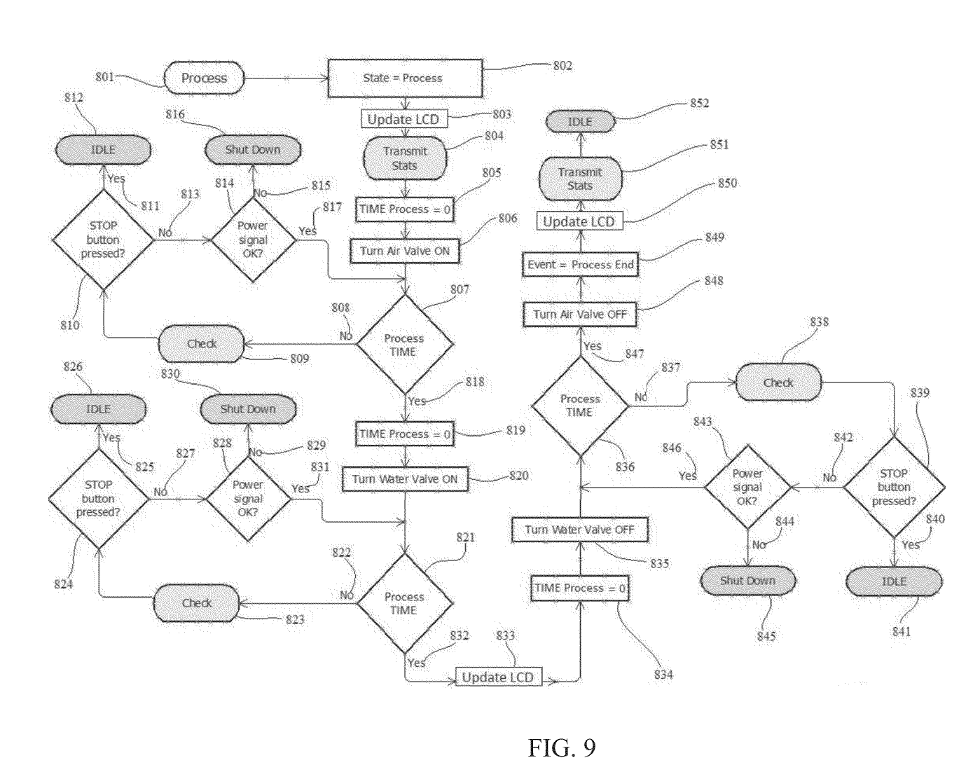

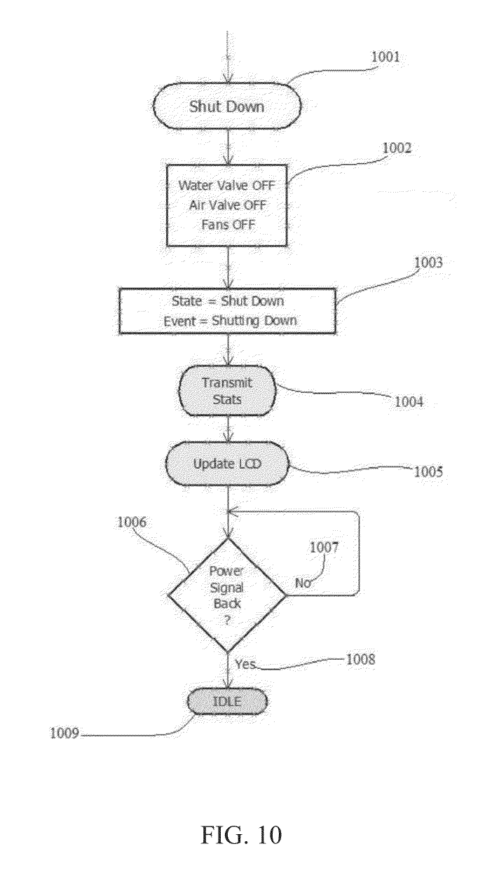

The electronics module 130 has a power switch 501, manual start button 502, manual stop button 503, cooling fans 504, LCD display 505, and Manual Mode/Automatic Mode switch 506. The electronics module 30 also has wired and/or wireless connection 507 to local area internet networks to send data to any remote monitoring system with an internet connection. This internet capability also allows the system to be controlled wirelessly over the internet. For example, the system can be turned on and off over the internet and the allowable parameters for sensor detection can be adjusted over the internet. Because, the electronics module 130 can be controlled using the various buttons and switches on the electronics module 130 itself, or remotely though a local area network, the operator can control and monitor the present invention on site or offsite. The programs for the electronics module 130 will be detailed fully using software flow diagrams as seen in FIG. 6, FIG. 7, FIG. 8, FIG. 9, and FIG. 10. The compilation of the electronics module programs provides the electronic control and monitoring system software. If the electronics module 130 receives electronic communication from one of the sensors, the electronic control and monitoring system software can be programmed to send signals or alerts to the operator via the wireless connection 507 or as messages to the LCD 504. The electronic control and monitoring system software also continuously logs data on system events and on received transmissions from the multiple sensors.

The solenoid water shut off valve 120, is used to start and stop water flow entering through inlet 31 as shown by arrow 508 through the system. The water temperature sensor 121 communicates electronically with the electronics module 130 in order to enable the electronic control and monitoring system software to log data or send an alert to the operator if water temperature deviates from a desired range. The water pressure sensor 122 communicates electronically with the electronics module 130 in order to enable the electronic control and monitoring system software to log data or send an alert to the operator if water pressure deviates from a desired range. The air pressure sensor 124 communicates electronically with the electronics module 130 in order to enable the electronic control and monitoring system software to log data or send an alert to the operator if air pressure deviates from a desired range. The solenoid air shut off 123 is used by the electronics module to start and stop air flow through the system entering at inlet 132 as indicated by arrow 509. The flow sensor 129 determines outlet flow from the system through outlet 133 as shown by arrow 510 and communicates electronically with the electronics module in order to enable the electronic control and monitoring system software to log data or send an alert to the operator if flow rate deviates from a desired range. The three mechanical regulators are: a water pressure regulator 118, an air pressure regulator 127, and a flow reducer 128.

The seven electronic devices, three mechanical regulators, the antimicrobial canister 108, the diffusion device 109, the manual water shut off 117, and water filter 119 are interconnected by the water line 116 and air line 123. The seven electronic devices are connected to the electronics module 130 by the electronic wiring 125. The electronic devices, mechanical devices, and the interconnecting plumbing lines and wires shown are all mounted to a mounting surface 115. An example set of parameters for the electronic control and monitoring system software might be programmed to monitor and control are the following: 140° F. water temperature, 15 psi of water pressure, 25 psi of air pressure, 2 gallon per minute (GPM) of flow rate, all with an acceptance range of within +/−15% before alerting the operator via warning and/or error messages displayed on the LCD screen on the electronics module 30 or through alerts transmitted over the local area network connection when the electronic control and monitoring system transmits a status report.

FIG. 6 shows a firmware flow diagram which the electronics module 130 is programmed to follow. Each circle in FIG. 6 represents a step in the system's electronic control and monitoring system software and each arrow represents an event, falling into one of two categories—an occurrence or a command. Upon an event, the electronic control and monitoring system software moves to another step. Beginning in the top left corner of the flow diagram and following the event arrows: the INITIALIZATION 601 sequence commences when the electronics module 30 is powered on. If INITIALIZATION 601 is successful as signified by Init complete 602, the system enters IDLE 603 state. Two options of state exist for IDLE 603 state; they are Manual mode and Automatic mode. Once in IDLE 603 mode, one of three events can occur, two of which are the commands: External Signal/command 604 and Start button 605 function according to whether the operator has selected Manual mode or Automatic mode using switch 506 on the electronics module 130. For example, in Automatic mode, an external signal from an outside device is required to advance the system from IDLE 603 state to PROCESS 606 mode whereas in Manual mode, the pressing of start button 502 on the electronics module 30 signals the Start button 605 command and advances the system from IDLE 603 state to PROCESS 606 mode. In either mode, signals from the other mode are not recognized. The third possible event is an occurrence, Power failure 610, which ultimately sends the system into a SHUTDOWN 611 sequence. If the system advances into PROCESS 606 mode, the following two commands can move the system from PROCESS 606 mode back to IDLE 603 state: Stop button 608 command (Manual mode) and Process complete command 607 (Automatic mode) The Stop button 608 command and Process complete 607 command are inverse events to the Start button 605 command and External signal/command 604 described above. In order for the system to move directly from PROCESS 606 mode to SHUTDOWN 611 sequence, a Power failure 610 must occur. Once the SHUTDOWN 611 sequence is complete, power must be restored, Power OK 612, in order for the system to return to INTIALIZATION 601, at which point the entire process will restart.

FIG. 7 shows a detailed flow diagram of the sequence that the electronic control and monitoring system software carries out to advance from INITIALIZATION 601 to IDLE 603 state. The flow diagram flows from top to bottom. Each shape represents a step in the sequence. Each arrow represents advancement from one step to the next. INITIALIZATION begins when power is supplied, Power On/reset 701, to the electronics module 30. Upon receiving power, the next step is for the electronic control and monitoring system to define its state−State=Init 703. Once INITIALIZATION 601 has been started, a Self Test 704 checks system functions including detection of pressures, temperatures, and flow-rate. Once the Self Test 704 is completed, IDLE is logged to non-volatile memory, timers are reset for IDLE state, the LCD is turned on if not already on, actual values of the desired parameters are displayed on the LCD, and the fan is turned on 705. At this point the system enters IDLE 603 state.

FIG. 8 shows a detailed flow diagram of all possible sequences of events to advance the electronic control and monitoring system software from IDLE 603 state to PROCESS 606 mode or SHUTDOWN 611 sequence. Each shape represents a step in each possible sequence. Each arrow represents advancement from one step to the next. Beginning at the top center of the flow diagram at IDLE 603 state, the next step is the IDLE state defined and set by the electronic control and monitoring system, as signified by State=IDLE 802. The next step is to Update the LCD 803 and following this, the a mode determination 804 is made of either Manual Mode 805 or Automatic Mode 812 which has been established by the operator using the Manual Mode/Automatic Mode switch on the electronics module 130. First, Manual 805 selection will be described. If Manual Mode is selected on the electronics module 30 switch, the electronic control and monitoring system software defines its state as Manual Mode 806. Next the Start button on the electronics module 30 is monitored 807 and if pressed by the operator 808 advances the system to the sub-state Manual 809. Once this state is confirmed by the electronic control and monitoring system software, PROCESS 606 mode is initiated. If the start button is not pressed 811, the system checks periodically for a specified number of seconds, as signified by Check 819. If the start button is not pressed 821 within the specified IDLE TIME 820, the event IDLE expired 822 is logged to non-volatile memory and that data is sent to off-site servers through a local area network 823 and the operator can be alerted, IDLE TIME is reset to zero 824 and Self Test 825 is conducted. After Self Test 825, the system returns to the same point in the sequence as if the idle time had not expired 826. In the next step, the electronic control and monitoring system software looks for Remote command 827 to be received. If Remote command is received 828, the Command Handler in the electronic control and monitoring system interprets and acts upon the Remote command 829 and returns to the same point in the sequence as if no Remote command was received 830. The next step is for the electronics control and monitoring system to check for Power signal 831. If Power signal is not OK 832, SHUTDOWN 611 sequence initiates. If Power signal is OK 834, the electronic control and monitoring system returns to the top level state=IDLE 802.

Now Automatic 813 state will be described. If the Manual Mode/Automatic Mode switch on the electronics module 130 is switched to Automatic Mode 812 while the system is in IDLE 801 mode, the electronic control and monitoring system software defines its state as Automatic Mode 813. Once Automatic Mode 813 state has been established, the system looks for an External signal 814. If an External signal is sensed 815, the sub-state, Automatic 816, is established by the electronic control and monitoring system software and PROCESS 606 mode is initiated. If no external signal is sensed 818 then the system returns to Check 819. If no External signals are received during Check, the electronic control and monitoring system proceeds to IDLE TIME 820 and sequenced as previously described.

FIG. 9 shows a detailed software flow diagram of all possible sequences that can advance the electronics control and monitoring system software from PROCESS 606 mode to IDLE 603 state or SHUTDOWN 611 sequence. Each shape represents a step in each possible sequence. Each arrow represents advancement from one step to the next. Beginning at the top left-center of the flow diagram at PROCESS 606 mode, the first step is the PROCESS mode defined and set by the electronic control and monitoring system software, as signified by State=Process 802. Once the Process state has been established, the LCD is updated 803 and the electronic control and monitoring system software will log the event to non-volatile memory and send it through a local area network to off-site servers and alert the operator if necessary, as signified by Transmit Stats 804. TIME Process is then set to zero, as signified by TIME Process=0 805, after which the electronic control and monitoring system opens the solenoid air shutoff valve 126 as signified by the Turn Air Valve On 806 step. Advancements within the process from one step to the next are referenced against time; therefore timing in the cycle is checked as signified by Process TIME 807. If time is not reset to zero 808, as signified by TIME Process=0 819 and the solenoid water shutoff valve 120 is not opened within the specified Process TIME 807, the system enters a check loop. Check loop defined: time is checked periodically for a pre-determined number of counts, as signified by Check 809. If the STOP button 810 is pressed 811 on the electronics module 30, the system returns to IDLE state 603; if not 813, power is checked as signified by Power signal OK? 814. If power is not confirmed within a programmed period 815, the system triggers SHUTDOWN 611 sequence. If power is confirmed 817, the system returns to Process TIME 807 and Check 807 is complete. If time is reset to zero, as signified by TIME Process=0 819, and the solenoid water shutoff valve 120 is actuated, as signified by Turn Water Valve ON 820 the timing of the cycle is checked again, as signified by Process TIME 821 and if timing cannot be confirmed, the system enters Check 823. If the STOP button 824 is pressed 825 on the electronics module 30, the system returns to IDLE state 603; if not 827, power is checked as signified by Power signal OK? 828. If power is not confirmed within a programmed period 829, the system triggers SHUTDOWN 611 sequence. If power is confirmed 831, the system returns to Process TIME 821 and check loop is complete. If timing is confirmed 832, the LCD is updated 833, and time is reset 834. Next the solenoid water valve is actuated 835. Process timing is checked 836. If timing is not correct 837, the system enters a check loop, Check 838. If the STOP button 839 is pressed 840 on the electronics module 130, the system returns to IDLE state 603; if not 842, power is checked as signified by Power signal OK? 843. If power is not confirmed within a programmed period 844, the system triggers SHUTDOWN 611 sequence. If power is confirmed 846, the system returns to Process TIME 836 and the check loop is complete. If timing is correct 847, the solenoid air shutoff valve 126 is closed as signified by Turn Air Valve OFF 848. Following the closure of the solenoid air shutoff valve 126, the PROCESS is logged as an event to non-volatile memory as signified by Event=Process End 849. Once logged, the event is displayed on the LCD 850. Next, this data is sent over the local area network to off-site servers, as signified by Transmit Stats 851. An operator is alerted if the transmitted stats deviate far enough from desired parameters. The system then returns to IDLE 603 state.

FIG. 10 shows a detailed software flow diagram of the electronic control and monitoring system advancing from SHUTDOWN 611 sequence to IDLE 603 state. Once SHUTDOWN 611 sequence has been initiated, the next step is for the electronic control and monitoring system software to close the solenoid water shutoff valve 120, solenoid air shutoff valve 126, and turn off the cooling fans inside the electronics module 130, all of which are signified by: Water Valve OFF, Air Valve OFF, and Fans OFF, respectively 1002. Once the necessary components are turned off, Shut Down state is established. In response to the establishment of Shut Down state, the event Shutting Down is logged to non-volatile memory as signified by State=Shut Down and Event=Shutting Down, respectively 1003. The logged even is then sent through a local area network to off-site servers, as signified by Transmit Stats 1004 at the request of the operator, the system can send an alert when it loses power. The next step updates the LCD screen on the electronics module 30 as signified by Update LCD 1005. The LCD update can display alerts for the operator. Next the power is checked as signified by Power Signal Back? 1006. If power requirements are not met 1007, the system remains powerless until power returns. If power requirements are met 1008 the system enters IDLE 603 state.

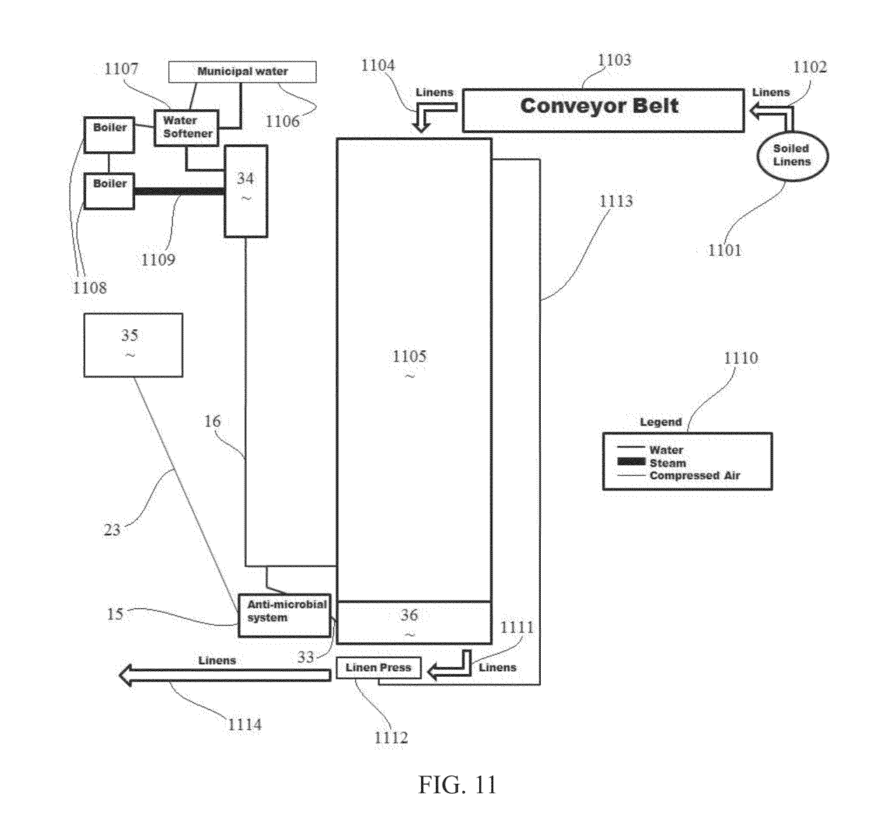

An example integration of the described embodiments into another system is described in more detail with reference to FIG. 11 which shows a schematic of an industrial laundry facility. The washing machine may have multiple modules, thereby known as a Continuous Batch Washer (CBW). FIG. 11 depicts an instance where the present invention is integrated into a CBW process. Linens enter the system soiled 1101 in batches of several hundred pounds and are transferred 1102 manually by plant workers to a conveyor belt 1103 that carries them to an elevated height where they are then gravity fed 1104 into the CBW. Water, Steam, and Compressed Air lines are defined in the schematic legend 1110. The most effective integration of the present invention into this particular example of an industrial laundry facility is represented in FIG. 11 through placement of the waterline 16 and antimicrobial fluid combination outlet 133 which the example embodiment uses to inject the antimicrobial agent into the CBW rinse module 136. The example embodiment from FIG. 5 is shown integrated into the industrial system as the mounting surface 15 through its connection with hot water source 134, pressurized air source 135 and the CBW rinse module 136. The hot water source 134 receives municipal water 1106 which is conditioned by a resin based, ion exchange, water softening system 1107 and is heated using multiple boilers 1108. The water line 116 connects the municipal water source 1106, water softener 1107, boilers 1108, hot water source 34, CBW wash modules 1105 and delivers water to the present invention 15 and the antimicrobial fluid combination outlet 33 delivers the antimicrobial agent into the CBW rinse module 136. Once the linens have been treated with the antimicrobial agent in the CBW rinse module 136, they are automatically loaded 1111 into a linen press 1112, which presses excess rinse water out of the linens. That pressed water is recycled back into the beginning of the CBW system through rinse water recycle line 1113. The rinse water recycle line 1113 is important to note because it reintroduces the antimicrobial agent into the beginning of the wash cycle. Upon exiting the press 1114, the linens may enter dryers or other machines within the laundry facility.

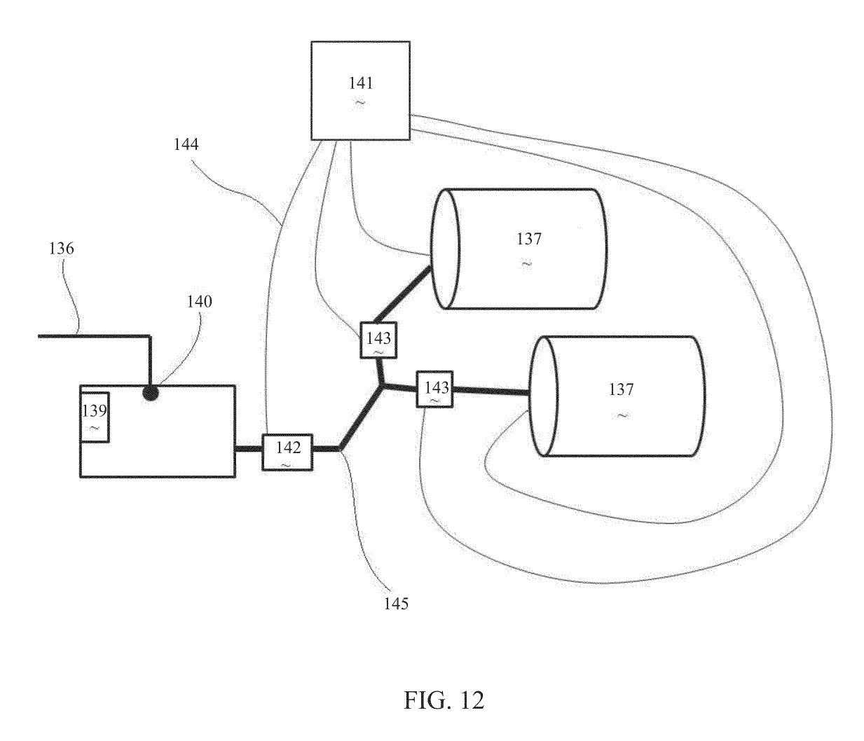

If the washing device does not have multiple modules, but rather a single module, possibly with different compartments, it is known as a Conventional Washer-Extractor (CWE) 137 and represented in FIG. 12. Additionally, FIG. 12 depicts an antimicrobial solution reservoir 138 which contains a float level sensor 139 that electronically signals the electronics module 130, in Automatic Mode, to cycle from IDLE state through its PROCESS mode until the antimicrobial solution reservoir 138 is full as electronically indicated by the float level sensor 39. The antimicrobial fluid combination outlet 133 is plumbed to the antimicrobial solution reservoir 138 by the antimicrobial reservoir inlet 140. Upon an external call signal from a CWE 137 to a node control module 141, the antimicrobial solution reservoir 138 will have stored antimicrobial solution expelled using an electronically actuated pump 142 which is electronically connected to the node control module 41 with signal wiring 144. The signal wiring 44 also electronically connects the node control module 141 to the CBWs 137 and the normally closed solenoid injection valves 143. The antimicrobial solution reservoir 138 is plumbed to the electronically actuated pump 142 using antimicrobial agent injection lines 145. Upon expulsion of the antimicrobial solution from the antimicrobial solution reservoir 138, the node control module 141 is programmed to actuate one of multiple normally closed solenoid injection valves 143 in order to be able to supply multiple CWEs with antimicrobial agent through the antimicrobial agent injection lines 145. In the case of CWE 137 system, the most effective integration of the present invention into the industrial laundry facility would be based on the time of injection, and would be to have the antimicrobial agent delivered into the CWE 137 during its final rinse cycle. In combination with electronic control and monitoring system software, the node control module 141 can be programmed, which allows the operator to fully program, and thus control, when the antimicrobial agent is delivered and how much of it is delivered.

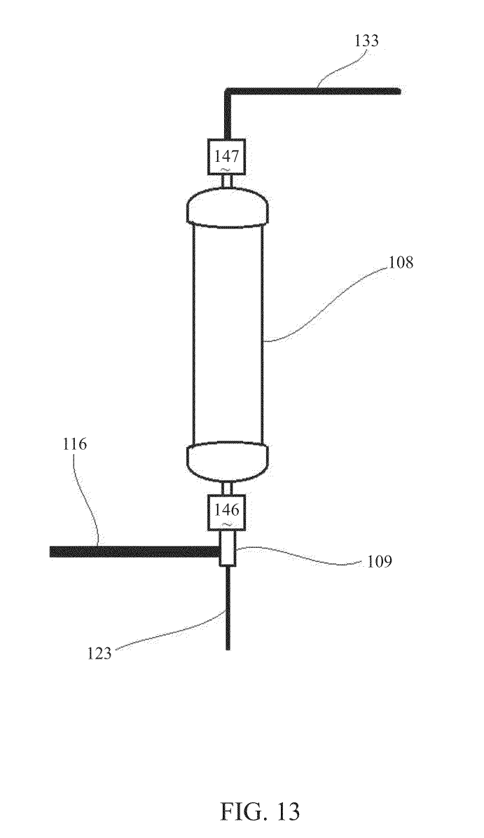

FIG. 13 shows a fluid microbial cleansing system comprised of six primary elements of the embodiment in FIG. 5 of the present invention with the addition of a fluid evaluation system. Fluid #1 is carried to the fluid diffusion device 9 through the water line 16. Fluid #2 is carried to the fluid diffusion device 109 through the air line 123. The fluid combination forms inside the fluid diffusion device 109 and before entering the antimicrobial canister 108, the fluid combination is measured by a fluid evaluation device such as a resistivity sensor 146. Once the fluid combination exits the antimicrobial canister 108 and before it is delivered to its application through the antimicrobial fluid combination outlet 133, it is measured a second time by a second fluid evaluation device such as resistivity sensor 147. Resistivity readings from the sensors 146 and 147 are compared to determine the level of antimicrobial ions present in the fluid combination for microbial cleansing. By measuring and comparing resistivity or conductivity of the fluid combination before it enters the antimicrobial canister 108 and after it exits the antimicrobial canister 108, the effectiveness of the antimicrobial canister and the level of ion generation enhanced by the fluid diffusion device can be evaluated for use in specific applications.

### Proportions and Approximate Dimensions of the Example Embodiments

Proportions and approximate sizes for an example embodiment may be described with reference to the drawings. Referring to FIG. 1A. The three components of the roll 104 have roughly equal width dimensions of about 18″. The antimicrobial metallic coated substrate 101 has the largest length of about 50″, the porous body 103 has the next largest length of about 36″ and the support frame 102 has the shortest length of about 24″. The thickness of the antimicrobial metallic coated substrate 101 is the smallest followed by the support frame 102 and finally the porous body 103 has the largest thickness. The thicknesses of the antimicrobial metallic coated substrate 101 and support frame 102 are less than ⅛″. The thickness of the porous body 3 ranges from ⅛″ and above.

Referring to FIG. 2A and FIG. 3A, the diameter of the roll 104 is equal to the inside diameter of the central cylinder 105 as seen in FIG. 3.The length of the roll 104 is equal to the length of the inside of the central cylinder 105. The length of the antimicrobial canister 108 can range from approximately 6″ to 36″ but may be even larger in certain applications. The relationship roughly follows that for each GPM of water set to flow through the antimicrobial canister 108, 9″ of central cylinder 105 length are ideal. The inlet end cap 106 and the outlet end cap 107 have inner diameters which are approximately equal to the outer diameter of the central cylinder 105 and an outer diameter which is slightly larger than that of the central cylinder 105.

Referring to FIG. 3A and FIG. 4, the cylindrical body of the fluid diffusion device 109 has a diameter which is less than or equal to the central cylinder 105. The diffuser 113 will have a diameter less than or equal to the cylindrical body of the fluid diffusion device 109. The diffuser 113 incorporates a barb 112 feeding air into a hollow porous diffusion material which resides inside the main body of the fluid diffusion device 109.

Referring to FIG. 5, the components which comprise the electronic control and monitoring system shown in FIG. 5 all mount onto the mounting surface 115 which has approximate width and length dimensions of 2′×4′. The water line 116 diameter can range from ¼″ tube to 2″ tube. The antimicrobial canister 108, manual water shut off 117, the water pressure regulator 118, water filter 119, the solenoid water shut off valve 120, the water temperature sensor 121, the water pressure sensor 122, the flow reducer 128, and the flow sensor 129 will all be plumbed to appropriately connect in-line with the water line 113. The airline can range from ¼″ to 1″ but the approximate diameter of the airline is ⅜″. The fluid diffusion device 109 will have a barb 112, which will connect in-line with the air line 123. The liquid inlet and fluid combination outlet of the fluid diffusion device 9 will connect in-line with the water line 116. The air pressure sensor 124, the solenoid air shut off 123, and the air pressure regulator 127 will all be plumbed to appropriately connect in-line with the air line 123.

The antimicrobial solution reservoir 138 should have a large enough volume to at least supply a conventional washer-extractor with 10% of its rinse water volume instantaneously. 450 lb CWEs 37 use roughly 50 gallons of rinse water. This means that for a standard, 450 lb capacity CWE 37, the antimicrobial solution reservoir 138 must be a minimum of 5 gallons. For each conventional washer extractor that must be supplied with antimicrobial solution, at least another 5 gallons must be added to the total volume of the antimicrobial solution reservoir. For example, to supply 5 CWEs 37, at a minimum, the antimicrobial solution reservoir 138 would need to be 25 gallons. There is no size limitation to the ant-microbial solution reservoir 138 other than space constraints in the installation site.

### Materials Used in the Example Embodiments

Referring again to FIG. 1A, the metallic antimicrobial coated substrate 101 shall be a material containing a metallic antimicrobial agent such as copper or silver and be pliable enough to roll into the roll 104 shown in FIG. 2A, in dimensions appropriate for and specific to a given implementation. In the example embodiment, the material employed for the coated substrate is a finely woven silver coated nylon cloth. The thickness of the silver coating on the nylon threads of this cloth can range from 100 nanometers to 10 microns in the example embodiment; an effective silver coating thickness has been found to be 500 nanometers (0.5 microns). The support frame 102 must be made of a material which is rigid enough when configured into the roll 104 and placed into antimicrobial canister 108 as shown in FIG. 3A to withstand the turbulated fluid combination flow experienced through the antimicrobial canister 108. The support frame 102 can be made from plastic or metal. In the example embodiment, the support frame 102 is a polyvinylchloride (PVC) grating. The porous body 103 must be able to allow sufficient fluid flow and be pliable enough to configure into the roll 104 seen in FIG. 2A and can be made from plastic, metal or foam. An effective material for the porous body has been found to be low density polyurethane (PU) foam.

The central cylinder 105, the inlet end cap 106, and the outlet end cap 107 seen in FIG. 3A, which house the roll 104, must be strong enough under pressure to avoid fracture or rupture at fluid pressure levels specific to implementations in industrial laundry plants; in the current embodiment, this maximum fluid pressure level is 100 psi. The end caps and central cylinder 105 can be made from metal or plastic. An effective material found for the central cylinder 105, inlet end cap 106 and outlet end cap 107 is schedule 80 PVC.

The diffuser 113 seen in FIG. 4 which adds separate fluid to the fluid passing through the main body of the fluid diffusion device 109 should be made of a porous metal or plastic in order to avoid fracture under pressure while allowing the diffusing action through its walls. The fluid diffusion device 109 main body should also be made of metal or plastic. An effective material found for the entire fluid diffusion device 109 including the barb 112 and diffuser 113 is stainless steel.

The mounting surface 115 should be made of metal, wood, or plastic in order to hold the mounted components seen in FIG. 5. The water line 116 should be made of corrosion resistant metal or plastic in order to withstand implementation and industrial laundry plant pressure without rupture. The air line 123 should be made of plastic or corrosion resistant metal in order to withstand implementation and industrial laundry plant pressure without rupture. All of the mechanical devices should be made of durable plastic such as polytetrafluoroethylene (PTFE) or metal; effective metals are stainless steel or aluminum to avoid silver cementation and corrosion. The electronic devices should have valve components made from rigid plastic in order to withstand frictional breakdown due frequent rubbing during on/off cycles.

The antimicrobial solution reservoir 135 should be made of a durable light-resistant polymer in order to avoid cementation and/or deterioration of the antimicrobial solutions during temporary storage.

### Operation of the Invention

To explain the operation of the present embodiment of the invention, the fluid motion through the various components along with the electronic control and monitoring of these fluids must be understood.

Many combinations of fluids (in their liquid or gaseous states) and materials are capable of creating effective antimicrobial treatments; water, air, and the combination of the two, referred to as the fluid combination, will be the three fluids described because of their use in the current embodiment of the invention. The metallic antimicrobial material described will be the previously cited silver coated nylon cloth. The following method description employs this specific set of fluids and materials which have been shown to produce effective antimicrobial treatment. Because specifics of the electronic control and monitoring system have been previously described in detail, the focus of this section will be on the materials science behind how the antimicrobial solution is generated.

Power is supplied to the electronics module 130. System INITIALIZATION begins. The manual water shut off valve 114 must be turned to the open position. Both of the electronic solenoid valves begin in the off position. Once timing and basic parameters are confirmed by the electronic control and monitoring system, IDLE state is established. The electronics module 130 has two modes by which to advance from IDLE state to PROCESS mode. Those modes are: Manual Mode and Automatic Mode. Manual mode uses the Start button and Stop button on the electronics module 130, at the command of the operator, in order to cycle the system through PROCESS mode, whereas Automatic Mode relies upon an external signal to cycle the system through PROCESS mode. In the case of integration into a CBW system, the external signal would come from the CBW computer control system. In the case of integration into a CWE system, the external signal would be transmitted from the float level sensor 136. Both PROCESS cycles of the electronic control and monitoring system are identical, and follow the flow diagram depicted in FIG. 6 and are detailed fully in supplementary FIGS. 7, 8, 9, and 10. They function as follows: The solenoid air shut off valve 126 is opened by electronic command of the electronics module 130. The electronics module 30 electronically commands the solenoid air shut off valve 126 to open before the electronics module 30 electronically commands the solenoid water shut off valve 120 to open. At this point, air from the pressurized air source 32 flows through the air pressure regulator 127, regulated to between 30 psi and 60 psi. This allows air to preload its flow through the air line 123 and continuously through the fluid diffusion device 109. Air enters the barb 112 and then enters the diffuser 113 and permeates the diffuser 113. After the programmed pause, the electronics module 130 electronically commands the solenoid water shut off valve 123 to open. Water entering the solenoid water shut off valve 120 from the hot water source 131 at between 120° F. and 170° F. is regulated to between 20 psi and 50 psi by the water pressure regulator 118. Different embodiments of the invention will have different ratios of fluid #1 to fluid #2; in the current embodiment, the flowing water pressure to flowing air pressure ratio is 4:5. The electronics module 130 then receives a water flow-rate reading from the flow sensor 129. It also receives readings from the water temperature sensor 121, water pressure sensor 122, and air pressure sensor 124. If the water flow rate, water temperature, water pressure, and air pressure are all reading within the programmed parameters then system PROCESS continues and the electronics control and monitoring system continues until an event sends the system back into IDLE state or SHUTDOWN sequence as shown in FIG. 6. If the water flow rate, water temperature, or water pressure readings are outside the programmed parameters then the electronics module 130 logs the event data to non-volatile memory, transmits the data through the local area network and alerts the operator. The electronics module 130 goes into a standby status until a command from the operator is received. At this point in the PROCESS sequence of the current embodiment, antimicrobial solution generation begins.

Upon the meeting of air through the diffuser 113 and water passing over the outside of the diffuser 113 as the water passes through the main body of the fluid diffusion device 109, the two fluids mix to form the fluid combination. The fluid combination is a water and air mixture. The maximum amount of gaseous oxygen from the air is dissolved into the water. The high dissolved oxygen level in the fluid combination makes the fluid combination corrosive. This corrosive behavior corrodes small amounts of the silver coating off of the silver coated nylon cloth 101 when the fluid combination comes in contact with the inside of antimicrobial canister 108, more specifically, the roll 104 inside the antimicrobial canister 108. The dissolved oxygen in the fluid combination reacts with the surface of the silver coated nylon cloth to form soluble silver oxides. These oxides dissolve, resulting in ionic silver in aqueous solution and oxygen free to form gaseous molecules or other compounds. The porous body 103 prevents laminar flow through the antimicrobial canister 108; it channels the fluid combination all throughout the layers of roll 4 inside of the antimicrobial canister 108 to promote even wear of the silver coated nylon cloth during the corrosion process. The fluid combination flows generally from inlet end cap 106 to outlet end cap 107 and exits through the water flow reducer 1 25 and flow sensor 129. The placement of the flow reducer 128 after the antimicrobial canister 8 in the system allows for the highest possible fluid pressure in the antimicrobial canister 8. This high fluid pressure is desired in order to keep the available oxygen dissolved in the fluid combination. The electronics module 130 takes a flow reading at the flow sensor 129 after it receives the pressure reading from the air pressure sensor 124. If the fluid combination flow through the flow sensor 129 is within the specified parameters then system PROCESS mode continues and the electronics module 130 continues to run PROCESS mode until an event occurs. If the flow rate is outside the specified parameters then the electronics module 130 the event data to non-volatile memory, transmits the data through the local area network and alerts the operator. The run sequence actively monitors transmissions delivered to the electronics module 130 from the 3 sensors and logs these transmissions to a non-volatile internal storage device and also optionally off site through the local area internet connection. Upon exiting the flow sensor 129 the fluid combination now contains dissolved ionic and nano-particle silver. In the case of CBW integration, the antimicrobial agent is delivered directly into the CBW rinse module 133. In the case of CWE 137 integration, the antimicrobial agent is temporarily stored in the antimicrobial solution reservoir 138 until the conventional CWE electronically signals the node control module 141 to trigger the electronically actuated pump 142 to turn on and the solenoid injection valves 143 to open, thereby forcing antimicrobial agent through the antimicrobial agent injection lines 145.

At this point the silver-containing fluid combination is a liquid antimicrobial agent ready to treat linens, surfaces, or other fluids in order to provide lasting antimicrobial treatment. The lasting effect is brought on by the residual tendency of silver and because silver is a heavy metal which behaves according to the Oligodynamic Effect. The electronics module 130 can be programmed to allow different combinations of temperature, air pressure, water pressure, and flow to adjust the corrosive properties of the fluid combination. By adjusting the level of corrosiveness, the silver concentration of the antimicrobial agent can be controlled. Using the previously cited effective set of materials and fluids, the antimicrobial device can be controlled to selectively produce aqueous ionic silver solutions ranging in concentration from 1 part per billion (ppb) to approximately 700 parts per billion (ppb) for example embodiments. The more corrosive the fluid combination is, the higher the silver concentration will be. The higher the silver concentration is in the antimicrobial agent, the stronger the antimicrobial effects will be and the longer they will last. Therefore, the present invention can be programmed to produce varying levels of antimicrobial treatment. One example of antimicrobial treatment is represented by FIG. 11, where the antimicrobial agent is delivered to an industrial CBW. The fine dispersion of silver ions and agglomerated silver particles which are corroded from the surface of the silver coated nylon cloth 101 while rolled in the roll 104 are what provide the antimicrobial properties of the antimicrobial agent in this example. The residual tendency of the fine silver dispersion provides the lasting antimicrobial effects.

### IMPLEMENTATION EXAMPLE 1

In studies for efficacy in determining silver ion concentration levels for impregnating fabric in laundry cycles, a 10 gallon bath simulating a washer rinse capacity was infused with silver ions at a concentration of 50 ppB and loaded with 1.5 kg of bed linen. A soak time of 2 minutes and 30 seconds was allowed and the linen removed and dried. Measured concentration level of ionic silver of 1.7 μg/kg of linens was obtained.

### IMPLEMENTATION EXAMPLE 2

For measurement of antimicrobial benefits to industrial laundry processes, the elements represented in FIG. 5 combined with those represented in FIG. 12 as described previously were assembled in an example implementation of the present invention into a CWE process that yields healthcare linens with desired silver content by weight for antimicrobial behavior in the linen.

Water as fluid #1 regulated to 38 psi, 150° F., flowing at 1 gpm and air as fluid #2 regulated to 47 psi flowing through the described embodiment produced antimicrobial solutions with ionic silver concentrations of between 160 ppb and 240 ppb. The antimicrobial solutions were stored in the antimicrobial reservoir during a CWE wash cycle. At the onset of the rinse cycle in the CWE containing 205 kg of healthcare bed linen, 60 gallons of antimicrobial solution was injected into the CWE from the reservoir. The antimicrobial solution was exposed to the 205 kg load of healthcare bed linen for 2 minutes and 50 seconds before the CWE drained and extracted the antimicrobial solution.

After the healthcare bed linen was dried and folded in the industrial process, samples were collected and analyzed for silver content by weight of healthcare bed linen. The treated linens contained an ionic silver concentration of 0.17 μg/kg of healthcare bed linen.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An antimicrobial device comprising:
a housing having an inlet and outlet for a turbulated fluid;
an insert contained in the housing, said insert containing a media impregnated with metal for production of antimicrobial metallic ions;
a fluid diffusion device connected upstream of the housing inlet and having fluid inlets for a first fluid and a second fluid, said first and second fluid combined in the fluid diffusion device as the turbulated fluid ; and,
means for controlling flow of the first and second fluids received by the fluid diffusion device for varying concentration of metallic ions entrained in the turbulated fluid.

2. The antimicrobial device defined in claim 1 wherein the housing is a cylindrical canister and the insert comprises a metallic coated substrate, support frame and porous body helically rolled within the canister.

3. The antimicrobial device defined in claim 2 further comprising fasteners inserted into the helically rolled insert to provide a constant flow cross section in each layer of the helically rolled insert.

4. The antimicrobial device defined in claim 1 wherein the housing is a cylindrical canister and the insert comprises a plurality of disks, each disk containing a media impregnated with metal for production of antimicrobial metallic ions.

5. The antimicrobial device defined in claim 4 wherein the media comprises resin balls.

6. The antimicrobial device defined in claim 4 wherein the media comprises a metallic impregnated substrate shredded into a confetti.

7. The antimicrobial device defined in claim 4 wherein the media comprises a metallic wool.

8. The antimicrobial device defined in claim 4 wherein the media comprises a metallic salt.

9. The antimicrobial device defined in claim 1 wherein the insert provides a gradient of impregnated metal for generation of antimicrobial metallic ions between the housing inlet and housing outlet.

10. The antimicrobial device defined in claim 9 wherein the gradient is determined by an ion uptake rate.

11. The antimicrobial device defined in claim 9 wherein the insert comprises a metallic coated substrate, support frame and porous body helically rolled, said metallic coated substrate having layers of predetermined length to provide said gradient.

12. The antimicrobial device defined in claim 9 wherein the insert comprises a plurality of disks, said disks stacked in adjacent engagement and each disk contains a predetermined amount of a media impregnated with metal for production of antimicrobial metallic ions, each adjacent disk containing a greater amount of media to achieve the desired gradient.

13. The antimicrobial device defined in claim 12 wherein the media is selected from the set of resin balls, metallic impregnated substrate shredded into confetti, a metallic wool or a metallic salt.

14. The antimicrobial device defined in claim 1 wherein the housing is cylindrical canister and further comprising a flow distribution puck.

15. The antimicrobial device defined in claim 14 wherein the flow distribution puck is perforated.

16. The antimicrobial device defined in claim 14 wherein the flow distribution puck is porous.

17. The antimicrobial device as defined in claim 1 wherein the metallic coating of the substrate is silver.

18. The antimicrobial device defined in claim 1 wherein the first fluid is water and the second fluid is air the means for controlling comprises:
a fluid pressure regulator connected to the fluid diffusion device water inlet,
an air pressure regulator connected to the fluid diffusion device air inlet; and
a flow reducer connected to the outlet of the housing.

19. The antimicrobial device defined in claim 18 further comprising:
a solenoid fluid shut off valve connected upstream of the fluid pressure regulator;
a temperature sensor for incoming water;
a fluid pressure sensor for incoming water;
an air pressure sensor for incoming air;
a solenoid air shut off valve connected upstream of the air pressure regulator; and
a flow sensor connected downstream of the flow reducer.

20. The antimicrobial device defined in claim 19 further comprising:
an electronic module connected to the temperature sensor, fluid pressure sensor, air pressure sensor and flow sensor for data input, said electronic module having a controller adapted for operation of at least the solenoid fluid shut off valve and solenoid air shut off valve responsive to the data input.
